(19) United States
(12) Patent Application Publication
(10) Pub. No.: US 2024/0034278 A1
(43) Pub. Date: Feb. 1, 2024

(54) SYSTEM AND METHOD FOR CLEANING SENSORS OF AUTONOMOUS VEHICLES WITH HEATED LIQUID

(71) Applicant: GM Cruise Holdings LLC, San Francisco, CA (US)

(72) Inventors: Nathaniel Barrett Herse, San Francisco, CA (US); Devin Cass, San Francisco, CA (US); Michael Shagam, San Francisco, CA (US); Isaac Brown, San Francisco, CA (US); Wesley Newhouse, San Francisco, CA (US); Kevin Sheppard, Oakland, CA (US)

(73) Assignee: GM Cruise Holdings LLC, San Francisco, CA (US)

(21) Appl. No.: 17/815,674

(22) Filed: Jul. 28, 2022

(51) Int. Cl. B60S 1/48; B60S 1/56; B60S 1/50; B60S 1/52

(52) U.S. Cl. CPC B60S 1/487; B60S 1/56; B60S 1/50; B60S 1/52; G01S 7/4043

(57) ABSTRACT

Liquid cleaning systems for cleaning AV sensors are disclosed herein. An example liquid cleaning system includes a reservoir storing a liquid. The liquid can flow from the reservoir to a heat exchanger. The heat exchanger can transfer heat generated by a part of the AV to the liquid, thereby improving cleaning efficacy. The part may be battery, motor, engine, sensor (e.g., the sensor to be cleaned with the liquid or another sensor), etc. The heat may be an unintended product of an operation of the part. The heat exchanger can use the heat to warm up the liquid and cool down the part. Additionally or alternatively, the liquid can be heated by another heat exchanger or a heater. The heater can generate heat intended for heating the liquid. The heater may be local to the sensor to be cleaned, e.g., the heater is closer to the sensor than the reservoir.

### TECHNICAL FIELD OF THE DISCLOSURE

The present disclosure relates generally to autonomous vehicles (AVs) and, more specifically, to cleaning sensors of AVs.

### BACKGROUND

An AV is a vehicle that is capable of sensing and navigating its environment with little or no user input. An autonomous vehicle may sense its environment using sensing devices such as Radio Detection and Ranging (RADAR), Light Detection and Ranging (LIDAR), image sensors, cameras, and the like. An autonomous vehicle system may also use information from a global positioning system (GPS), navigation systems, vehicle-to-vehicle communication, vehicle-to-infrastructure technology, and/or drive-by-wire systems to navigate the vehicle. As used herein, the phrase “autonomous vehicle” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs, according to some embodiments of the present disclosure;

FIG. 2 is a block diagram showing a sensor suite, according to some embodiments of the present disclosure;

FIG. 3 is a block diagram showing an onboard computer, according to some embodiments of the present disclosure;

FIG. 4 illustrates an example liquid cleaning system including a heat exchanger, according to some embodiments of the present disclosure;

FIG. 5 illustrates an example liquid cleaning system including two heat exchangers, according to some embodiments of the present disclosure;

FIG. 6 illustrates another example liquid cleaning system including two heat exchangers, according to some embodiments of the present disclosure;

FIG. 7 illustrates yet another example liquid cleaning system including local heaters, according to some embodiments of the present disclosure;

FIG. 8 illustrates an example liquid cleaning system including a heat exchanger and local heaters, according to some embodiments of the present disclosure;

FIG. 9 illustrates an example liquid cleaning system including a local heater and heat exchangers, according to some embodiments of the present disclosure;

FIG. 10 illustrates an example liquid cleaning system including a reservoir heater, according to some embodiments of the present disclosure; and

FIG. 11 is a block diagram showing a fleet management system, according to some embodiments of the present disclosure.

### DESCRIPTION OF EXAMPLE EMBODIMENTS OF THE DISCLOSURE

Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

As described herein, AV sensors can be cleaned by using warm liquid. A liquid for cleaning one or more sensors of an AV can be warmed up by utilizing heat generated by one or more other parts of the AV. An example part may be a battery, motor, engine, sensor (the sensor to be cleaned or another sensor), etc. The heat generated by a part may be an unintended or even undesired result of an operation of the part. For instance, a battery can generate heat during its operation. However, the heat may impair performance or lifetime of the battery or another part. Heating the liquid with such heat not only can enhance the cleaning effect of the liquid but also can cool down the part and avoid overheating of the part (or another part influenced by the heat).

An example liquid cleaning system of the present disclosure includes a reservoir storing a cleaning liquid (also referred to as “liquid”). The liquid can be used to clean AV sensors, e.g., sensors at the exterior of AVs. The liquid can also be used to clean other AV parts, e.g., wind shield, mirror, and so on. To clean a sensor, the liquid may be sprayed onto one or more surfaces of the sensor, e.g., by a spraying nozzle. A surface may be a window, an enclosure, a lens, a filter, and so on. Before the liquid is sprayed, the liquid can be heated by using one or more heat sources. The liquid can flow between the reservoir, heat sources, and spraying nozzles through various flow channels formed in association with the AV.

An example heat source is a heat exchanger. The heat exchanger can transfer heat from an AV part to the liquid. In some embodiments, the heat exchanger includes a container or a flow channel with thermally conductively walls. Heat can be transferred from the part to the liquid when the liquid is in the heat exchanger. Another example heat source is a heater that generates heat intended for heating the liquid. An example heater may be a local heater to the sensor to be cleaned, e.g., the heater is closer to the sensor than the reservoir. With such a local heater, the loss of heat due to liquid flow from the reservoir to the spraying nozzle can be minimized. Another example heater can be inside the reservoir. For instance, the heater can be immersed in the liquid. Yet another example heater may be a local heater to another AV part to be cleaned by the liquid, e.g., the wind shield. The local heater can be closer to the other AV part than the sensor. As the liquid has a higher temperature, the cleaning effect can be better, e.g., as hotter liquid can dissolve more contaminants, or dissolve contaminants faster, than colder liquid.

A liquid cleaning cycle (i.e., a cycle of using a liquid to clean an AV sensor) may be controlled by the onboard computer of the AV. In some embodiments, the onboard computer may control a heat source. The onboard computer may control a temperature of the heat source, a duration of time that the liquid is being heated by the heat source, liquid flowing into the heat source, liquid flowing out of the heat source, and so on. The onboard computer may also control a spraying nozzle that sprays a cleaning liquid, e.g., by actuating a solenoid relay in a manifold. For instance, the onboard computer can control the amount of cleaning liquid sprayed by the spraying nozzle, a flowing speed of the liquid in or at the spraying nozzle, and so on. The onboard computer may also control a flow channel. For instance, the onboard computer can control a flow rate of the liquid flowing in the flow channel, a valve associated with the flow channel, and so on.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Example AV System

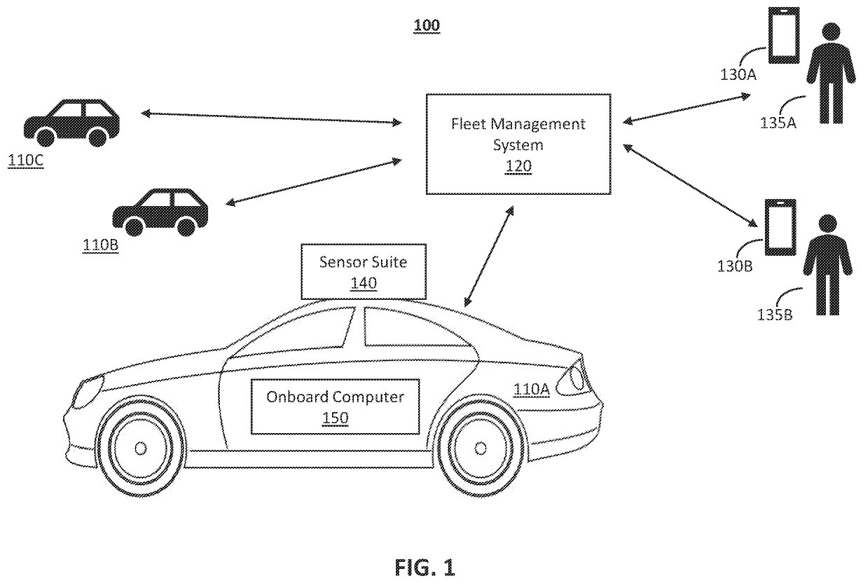

FIG. 1 illustrates a system 100 including a fleet of AVs, according to some embodiments of the present disclosure. The system 100 includes a fleet of AVs 110A-C (collectively referred to as “AV 110” or “AVs 110”), a fleet management system 120, and user devices 130A and 130B (collectively referred to as “user device 130” or “user devices 130”). For purpose of simplicity and illustration, in FIG. 1, the AV 110A includes a sensor suite 140 and an onboard computer 150. The AV 110B or 110C may also include a sensor suite 140 and an onboard computer 150. In other embodiments, the system 100 may include fewer, more, or different components. For instance, the system 100 may include a different number of AVs 110, a different number of user devices 130, etc.

The fleet management system 120 receives service requests for the AVs 110 from the user devices 130. As shown in FIG. 1, the user devices 130A and 130B are associated with users 135A and 135B, respectively. The users 135A and 135B are collectively referred to as “user 135” or “users 135.” In other embodiments, a single user device 130 may be associated with multiple users 135. Also, a single user 135 may be associated with multiple user devices 130. A user device 130 may be one or more computing devices capable of receiving user input as well as transmitting and/or receiving data via one or more networks, e.g., a network through which the user device 130 can communicate with the fleet management system 120. In one embodiment, a user device 130 is a conventional computer system, such as a desktop or a laptop computer. Alternatively, a user device 130 may be a device having computer functionality, such as a personal digital assistant (PDA), a mobile telephone, a smartphone, or another suitable device.

In some embodiments, a user device 130 executes an application allowing a user 135 of the user device 130 to interact with the fleet management system 120. For example, a user device 130 executes a browser application to enable interaction between the user device 130 and the fleet management system 120 via a network. In another embodiment, a user device 130 interacts with the fleet management system 120 through an application programming interface (API) running on a native operating system of the user device 130, such as IOS® or ANDROID™. The application may be provided and maintained by the fleet management system 120. The fleet management system 120 may also update the application and provide the update to the user device 130.

In some embodiments, a user 135 may make various service requests to the fleet management system 120 through a user device 130. A user device 130 may provide its user 135 a user interface (UI), through which the user 135 can make service requests. For instance, a user 135 may make ride requests (e.g., a request to pick up a person from a pickup location and drop off the person at a destination location), delivery requests (e.g., a request to delivery one or more items from a location to another location), or requests for other services that the AVs 110 can provide. The UI may allow users 135 to provide locations (e.g., pickup location, destination location, etc.) or other information that would be needed by AVs 110 to provide services requested by the users 135.

The AV 110 may be a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., wind shield wipers, headlights, turn indicators, air conditioning, etc.

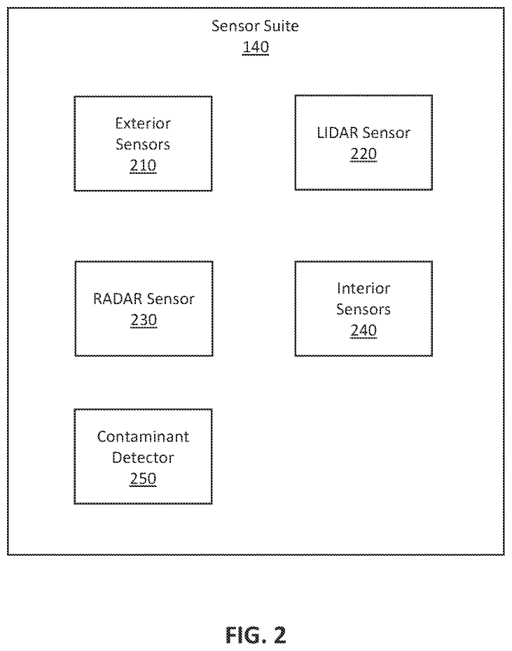

As shown in FIG. 1, the AV 110 includes a sensor suite 140 and an onboard computer 150. The sensor suite 140 includes one or more sensors that can detect one or more features associated with the AV 110. Example features include features in an environment around the AV 110, features on the exterior of the AV 110, features inside the AV 110, and so on. The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUs), accelerometers, microphones, strain gauges, pressure monitors, barometers, thermometers, altimeters, ambient light sensors, and so on. The sensors may be located in various positions in and around the AV 110. For example, the AV 110 may have multiple cameras located at different positions around the exterior and/or interior of the AV 110. Certain aspects of the sensor suite 140 are described below in conjunction with FIG. 2.

The onboard computer 150 is connected to the sensor suite 140 and functions to control the AV 110 and to process sensed data from the sensor suite 140 and/or other sensors in order to determine the state of the AV 110. Based upon the vehicle state and programmed instructions, the onboard computer 150 modifies or controls behavior of the AV 110. The onboard computer 150 is preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

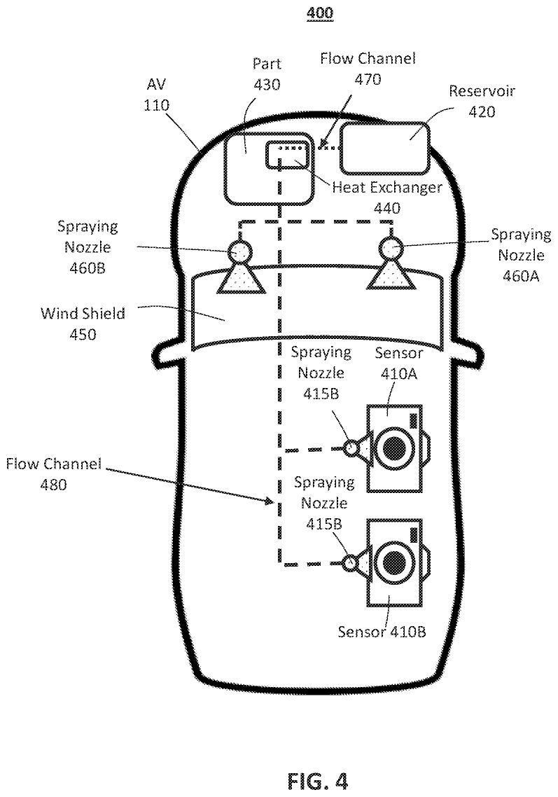

The onboard computer 150 can also maintain the sensor suite 140. In some embodiments, the onboard computer 150 monitors conditions of sensors in the sensor suite 140. For instance, the onboard computer 150 can maintain cleanness of sensors. The cleanness of sensors can be important to performance of the AV 110. For instance, the cleanness of a sensor can influence the accuracy in the detection of the sensor, which can further influence the performance of the AV 110 as the AV 110 operates based on the detection of the sensor. The onboard computer 150 may determine whether a sensor needs cleaning and in response to determining that the sensor needs cleaning, the onboard computer 150 can control a liquid cleaning system to clean the sensor. Examples of the liquid cleaning system include the liquid cleaning system 400, 500, 600, 700, 800, 900, and 1000 described below in conjunction with FIGS. 4-10.

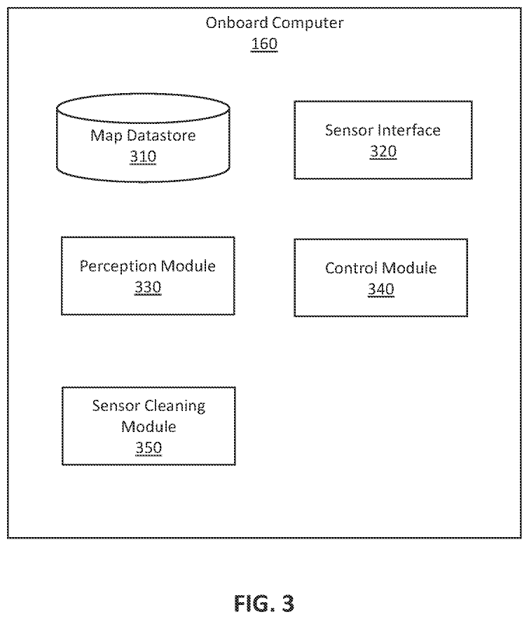

In some embodiments, the onboard computer 150 may determine that a sensor needs cleaning based on detection of contamination (e.g., dust, dirt, fingerprints, moisture, bug splatter, birth feces, mud splatter, etc.) of the sensor, e.g., by using sensor data captured by the sensor itself, sensor data captured by one or more other sensors, or some combination thereof. In alternative embodiments, the onboard computer 150 may request sensor cleaning on a regular basis. For instance, the onboard computer 150 may determine a schedule of cleaning a sensor and request sensor cleaning based on the schedule. Certain aspects regarding the onboard computer 150 are described below in conjunction with FIG. 3.

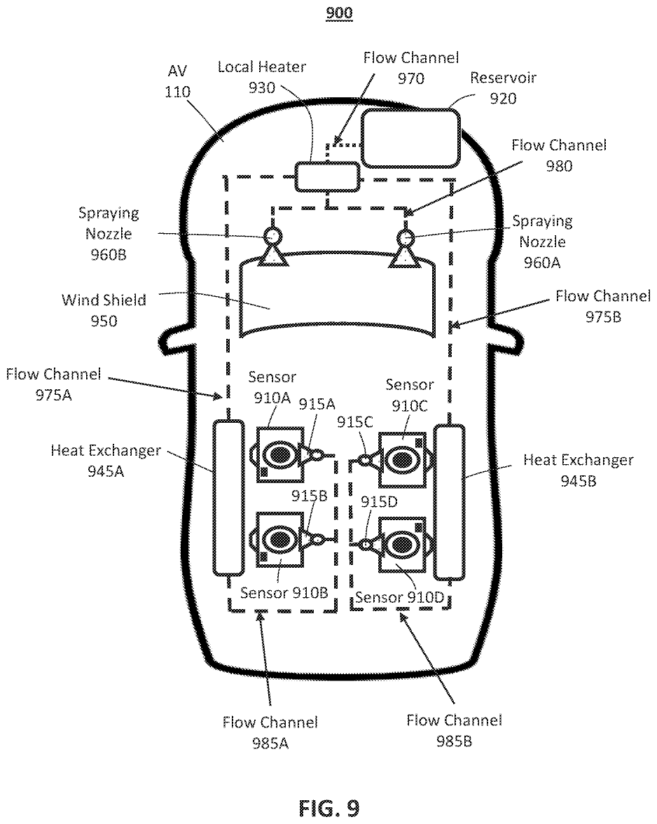

The fleet management system 120 manages the fleet of AVs 110. The fleet management system 120 may manage one or more services that provides or uses the AVs, e.g., 3D printing service, ride service, delivery service, and so on. The fleet management system 120 selects one or more AVs (e.g., AV 110A) from a fleet of AVs 110 to perform a particular service or other task, and instructs the selected AV to provide the service. The fleet management system 120 may also send the selected AV information that the selected AV may use to complete the service. The fleet management system 120 also manages fleet maintenance tasks, such as fueling, inspecting, calibrating, and servicing of the AVs. As shown in FIG. 1, the AVs 110 communicate with the fleet management system 120. The AVs 110 and fleet management system 120 may connect over a public network, such as the Internet. Certain aspects regarding the fleet management system 120 are described below in conjunction with FIG. 9.

### Example Sensor Suite

FIG. 2 is a block diagram showing the sensor suite 140, according to some embodiments of the present disclosure. The sensor suite 140 includes exterior sensors 210, a LIDAR sensor 220, a RADAR sensor 230, interior sensors 240, and a contaminant detector 250. The sensor suite 140 may include any number of the types of sensors shown in FIG. 2, e.g., one or more LIDAR sensor 220, one or more LIDAR sensors 220, or one or more contamination detectors 250. The sensor suite 140 may have more types of sensors than those shown in FIG. 2, such as the sensors described with respect to FIG. 1. In other embodiments, the sensor suite 140 may not include one or more of the sensors shown in FIG. 2.

The exterior sensors 210 detect objects in an environment around the AV 110. The environment may include a scene in which the AV 110 operates. Example objects include persons, buildings, traffic lights, traffic signs, vehicles, street signs, trees, plants, animals, or other types of objects that may be present in the environment around the AV 110. An exterior sensor 210 may be affixed to an exterior surface of the AV 110, e.g., either directly (e.g., the exterior sensor 210 is attached on the exterior surface of the AV 110) or indirectly (e.g., the exterior sensor 210 is affixed to a structure that is attached on the exterior surface of the AV 110).

In some embodiments, the exterior sensors 210 include exterior cameras having different views, e.g., a front-facing camera, a back-facing camera, and side-facing cameras. One or more exterior sensors 210 may be implemented using a high-resolution imager with a fixed mounting and field of view. One or more exterior sensors 210 may have adjustable field of views and/or adjustable zooms. In some embodiments, the exterior sensors 210 may operate continually during operation of the AV 110. In an example embodiment, the exterior sensors 210 capture sensor data (e.g., images, etc.) of a scene in which the AV 110 drives. In other embodiment, the exterior sensors 210 may operate in accordance with an instruction from the onboard computer 150 or an external system, such as the fleet management system 120. Some of all of the exterior sensors 210 may capture sensor data of one or more objects in an environment surrounding the AV 110 based on the instruction.

The LIDAR sensor 220 measures distances to objects in the vicinity of the AV 110 using reflected laser light. The LIDAR sensor 220 may be a scanning LIDAR that provides a point cloud of the region scanned. The LIDAR sensor 220 may have a fixed field of view or a dynamically configurable field of view. The LIDAR sensor 220 may produce a point cloud that describes, among other things, distances to various objects in the environment of the AV 110.

The RADAR sensor 230 can measure ranges and speeds of objects in the vicinity of the AV 110 using reflected radio waves. The RADAR sensor 230 may be implemented using a scanning RADAR with a fixed field of view or a dynamically configurable field of view. The RADAR sensor 230 may include one or more articulating RADAR sensors, long-range RADAR sensors, short-range RADAR sensors, or some combination thereof.

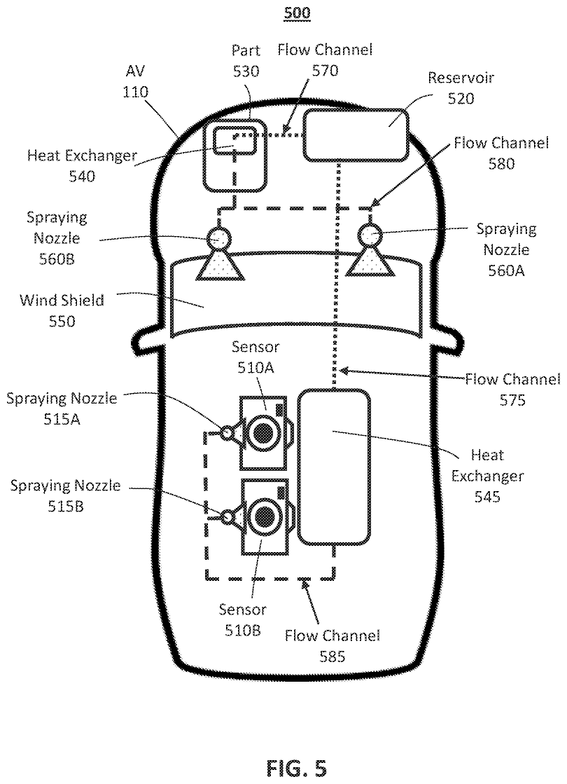

The interior sensors 240 detect the interior of the AV 110, such as objects inside the AV 110. Example objects inside the AV 110 include passengers, client devices of passengers, components of the AV 110, items delivered by the AV 110, items facilitating services provided by the AV 110, and so on. The interior sensors 240 may include multiple interior cameras to capture different views, e.g., to capture views of an interior feature, or portions of an interior feature. The interior sensors 240 may be implemented with a fixed mounting and fixed field of view, or the interior sensors 240 may have adjustable field of views and/or adjustable zooms, e.g., to focus on one or more interior features of the AV 110. The interior sensors 240 may transmit sensor data to a perception module (such as the perception module 330 described below in conjunction with FIG. 5), which can use the sensor data to classify a feature and/or to determine a status of a feature.

In some embodiments, some or all of the interior sensors 240 may operate continually during operation of the AV 110. In other embodiment, some or all of the interior sensors 240 may operate in accordance with an instruction from the onboard computer 150 or an external system. The interior sensors 240 may include a camera that can capture images of passengers. The interior sensors 240 may also include one or more microphones that can capture sound in the AV 110, such as a conversation made by a passenger.

The contaminant detector 250 detects contamination of one or more other sensors in the sensor suite 140, such as one or more exterior sensors 210, one or more LIDAR sensors 220, one or more RADAR sensors 230, one or more interior sensors 240, or some combination thereof. The contaminant detector 250 may detect contaminants accumulated on a sensor, such as on a portion, a surface, or a component of a sensor. Additionally or alternatively, the contaminant detector 250 may detect contaminants in an environment surrounding a sensor. For instance, the contaminant detector 250 can detect objects in the environment that can contaminate the sensor and undermine performance of the sensor. Such objects may also be referred to as contaminants. Example contaminants include dirt, dust, dirt, moisture, or other objects that can contaminate the sensor and undermine performance of the sensor. The contaminant detector 250 may capture sensor data indicating a contaminant level of the environment.

The contaminant detector 250 may be associated with one or more other sensors of the sensor suite 140 and detect contaminations for the one or more other sensors. The contaminant detector 250 may be affixed on the one or more other sensors or be physically separately from the one or more other sensors. In some embodiments, the contaminant detector 250 is one of the exterior sensors 210 or one of the interior sensors 240.

### Example Onboard Computer

FIG. 3 is a block diagram showing the onboard computer 150, according to some embodiments of the present disclosure. The onboard computer 150 includes map datastore 310, a sensor interface 320, a perception module 330, a control module 340, and a sensor cleaning module 350. In alternative configurations, fewer, different and/or additional components may be included in the onboard computer 150. For example, components and modules for conducting route planning, controlling movements of the AV 110, and other vehicle functions are not shown in FIG. 3. Further, functionality attributed to one component of the onboard computer 150 may be accomplished by a different component included in the onboard computer 150 or a different system from those illustrated, such as a liquid cleaning system or the fleet management system 120.

The map datastore 310 stores a detailed map of environments through which the AV 110 may travel. The map datastore 310 may store environmental features captured by exterior sensors (e.g., the exterior sensor 210) of the AV 110. In some embodiments, the map datastore 310 may also store environmental features captured by other AVs. In some embodiments, the map datastore 310 includes data describing roadways, such as locations of roadways, connections between roadways, roadway names, speed limits, traffic flow regulations, toll information, etc. The map datastore 310 may further include data describing buildings (e.g., locations of buildings, building geometry, building types), and data describing other objects (e.g., location, geometry, object type) that may be in the environments of an AV. The map datastore 310 may also include data describing other features, such as bike lanes, sidewalks, crosswalks, traffic lights, parking lots, signs, billboards, etc. In some embodiments, the map datastore 310 stores map data for a city or region in which the AV 110 is located.

Some of the map datastore 310 may be gathered by the AV 110. For example, images obtained by exterior sensors (e.g., the exterior sensor 210) of the AV 110 may be used to learn information about the AV′ environments. The output of the exterior sensors may be processed to identify particular conditions in the environment, such as road conditions, weather conditions, etc. In some embodiments, certain map data (e.g., conditions that are expected to be temporary) may expire after a certain period of time. In some embodiments, data captured later by the AV 110 or a different AV may indicate that a previously-observed feature is no longer present (e.g., weather has been changed, construction work zone has been removed, etc.) and in response, the map data may be removed from the map datastore 310.

The sensor interface 320 interfaces with the sensors in the sensor suite 140. The sensor interface 320 is configured to receive data captured by sensors of the sensor suite 140, including data from exterior sensors mounted to the outside of the AV 110, and data from interior sensors mounted in the passenger compartment of the AV 110. The sensor interface 320 may have subcomponents for interfacing with individual sensors or groups of sensors of the sensor suite 140, such as a camera interface, a LIDAR interface, a RADAR interface, a microphone interface, etc.

The sensor interface 320 may also request data from the sensor suite 140, e.g., by requesting that a sensor capture data in a particular direction or at a particular time. For example, the sensor interface 320 may request an interior sensor (e.g., the interior sensor 240) to detect one or more features in the AV 110 periodically to monitor status of the features and to facilitate timely replacement of a feature if the feature malfunctions. As another example, in response to the perception module 330 or another module determining that a feature in the AV 110 malfunctions, the sensor interface 320 instructs the interior sensor to capture additional data (e.g., dimensions, shape, etc.) of the feature, e.g., by zooming in and focusing on the feature.

The perception module 330 identifies objects and/or other features captured by the sensors of the AV 110. For example, the perception module 330 identifies objects in the environment of the AV 110 and captured by one or more exterior sensors (e.g., the sensors 210-230). The perception module 330 may include one or more classifiers trained using machine learning to identify particular objects. For example, a multi-class classifier may be used to classify each object in the environment of the AV 110 as one of a set of potential objects, e.g., a vehicle, a pedestrian, or a cyclist. As another example, a pedestrian classifier recognizes pedestrians in the environment of the AV 110, a vehicle classifier recognizes vehicles in the environment of the AV 110, etc. The perception module 330 may identify travel speeds of identified objects based on data from the RADAR sensor 230, e.g., speeds at which other vehicles, pedestrians, or birds are traveling. As another example, the perception module 33—may identify distances to identified objects based on data (e.g., a captured point cloud) from the LIDAR sensor 220, e.g., a distance to a particular vehicle, building, or other feature identified by the perception module 330. The perception module 330 may also identify other features or characteristics of objects in the environment of the AV 110 based on image data or other sensor data, e.g., colors (e.g., the colors of Christmas lights), sizes (e.g., heights of people or buildings in the environment), makes and models of vehicles, pictures and/or words on billboards, etc.

The perception module 330 may further process data from captured by interior sensors (e.g., the interior sensors 240 of FIG. 2) to determine information about and/or behaviors of passengers in the AV 110. For example, the perception module 330 may perform facial recognition based on sensor data from the interior sensors 240 to determine which user is seated in which position in the AV 110. As another example, the perception module 330 may process the sensor data to determine passengers' states, such as gestures, activities (e.g., whether passengers are engaged in conversation), moods (whether passengers are bored (e.g., having a blank stare, or looking at their phones)), and so on. The perception module may analyze data from the interior sensors 240, e.g., to determine whether passengers are talking, what passengers are talking about, the mood of the conversation (e.g., cheerful, annoyed, etc.). In some embodiments, the perception module 330 may determine individualized moods, attitudes, or behaviors for the users, e.g., if one user is dominating the conversation while another user is relatively quiet or bored; if one user is cheerful while the other user is getting annoyed; etc. In some embodiments, the perception module 330 may perform voice recognition, e.g., to determine a response to a game prompt spoken by a user.

In some embodiments, the perception module 330 fuses data from one or more interior sensors 240 with data from exterior sensors (e.g., exterior sensors 210) and/or map datastore 310 to identify environmental objects that one or more users are looking at. The perception module 330 determines, based on an image of a user, a direction in which the user is looking, e.g., a vector extending from the user and out of the AV 110 in a particular direction. The perception module 330 compares this vector to data describing features in the environment of the AV 110, including the features' relative location to the AV 110 (e.g., based on real-time data from exterior sensors and/or the AV's real-time location) to identify a feature in the environment that the user is looking at.

While a single perception module 330 is shown in FIG. 3, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 340 controls operations of the AV 110, e.g., based on information from the sensor interface 320 or the perception module 330. In some embodiments, the control module 340 controls operation of the AV 110 by using a trained model, such as a trained neural network. The control module 340 may provide input data to the control model, and the control model outputs operation parameters for the AV 110. The input data may include sensor data from the sensor interface 320 (which may indicate a current state of the AV 110), objects identified by the perception module 330, or both. The operation parameters are parameters indicating operation to be performed by the AV 110. The operation of the AV 110 may include perception, prediction, planning, localization, motion, navigation, other types of operation, or some combination thereof. The control module 340 may provide instructions to various components of the AV 110 based on the output of the control model, and these components of the AV 110 will operation in accordance with the instructions. In an example where the output of the control model indicates that a change of traveling speed of the AV 110 is required given a prediction of traffic condition, the control module 340 may instruct the motor of the AV 110 to change the traveling speed of the AV 110. In another example where the output of the control model indicates a need to detect characteristics of an object in the environment around the AV 110 (e.g., detect a speed limit), the control module 340 may instruct the sensor suite 140 to capture an image of the speed limit sign with sufficient resolution to read the speed limit and instruct the perception module 330 to identify the speed limit in the image.

The sensor cleaning module 350 manages cleaning of one or more sensor in the sensor suite 140. In some embodiments, the sensor cleaning module 350 may manage the cleaning of a category of sensors, e.g., optical sensors or other types of sensors. The sensor cleaning module 350 may control operation of one or more liquid cleaning systems for cleaning sensors. Example liquid cleaning systems including liquid cleaning systems 400, 500, 600, 700, and 800 described below in conjunctions with FIGS. 4A-4B and 5-8. In some embodiments, some or all functions of the sensor cleaning module 350 may be performed by one or more components of the liquid cleaning systems.

The sensor cleaning module 350 may determine whether a sensor (e.g., a surface of a sensor) needs cleaning. In some embodiments, the sensor cleaning module 350 uses sensor data to determine whether a sensor needs cleaning. The sensor data may be from the sensor itself or another sensor, e.g., the contaminant detector 250 in FIG. 2. The sensor cleaning module 350 may request the sensor data, e.g., through the sensor interface 320.

The sensor cleaning module 350 may determine a contamination condition of the sensor based on the sensor data. In an example, the sensor cleaning module 350 may identify, from the sensor data, contaminants accumulated on the sensor. The identification of the contaminants may alternatively be done by the perception module 330, which can provide information of the identification to the sensor cleaning module 350. The sensor cleaning module 350 may determine whether the contamination condition of the sensor meets a threshold condition, e.g., a threshold number of contaminants, a threshold concentration of contaminants (e.g., number per unit area or unit volume), and so on. In response to determining that the contamination condition of the sensor meets the threshold condition, the sensor cleaning module 350 determines that the sensor needs cleaning. In another example, the sensor cleaning module 350 may determine a performance of the sensor based on the sensor data. The performance may be an accuracy, brightness, signal-to-noise ratio, or other attributes of the sensor data. The sensor cleaning module 350 can compare the performance of the sensor with a corresponding predetermined performance (e.g., required performance, expected performance, etc.) of the sensor and in response to determining that the performance of the sensor does not meet the predetermined performance, the sensor cleaning module 350 determines that the sensor needs cleaning.

In addition or alternative to sensor data, the sensor cleaning module 350 may use other data to determine whether a sensor needs clean. For instance, the sensor cleaning module 350 may determine a frequency of cleaning a sensor. The frequency indicates how often the sensor needs cleaning. The sensor cleaning module 350 may determine the frequency based on one or more attributes of the sensor (e.g., pose (position, orientation, or both) of the sensor, material of the sensor, sensitivity to contaminants, etc.), one or more attributes of the environment surrounding the sensor (e.g., cleanness of the environment, weather of the environment, etc.). The sensor cleaning module 350 can maintain a record of historical cleanings of the sensor and/or determine a time for the next cleaning. The sensor cleaning module 350 can determine that the sensor needs cleaning when the determined time is reached.

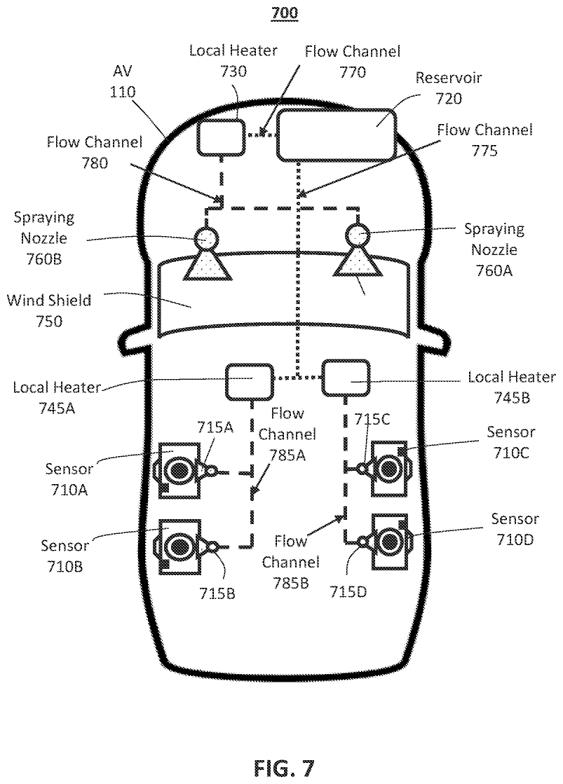

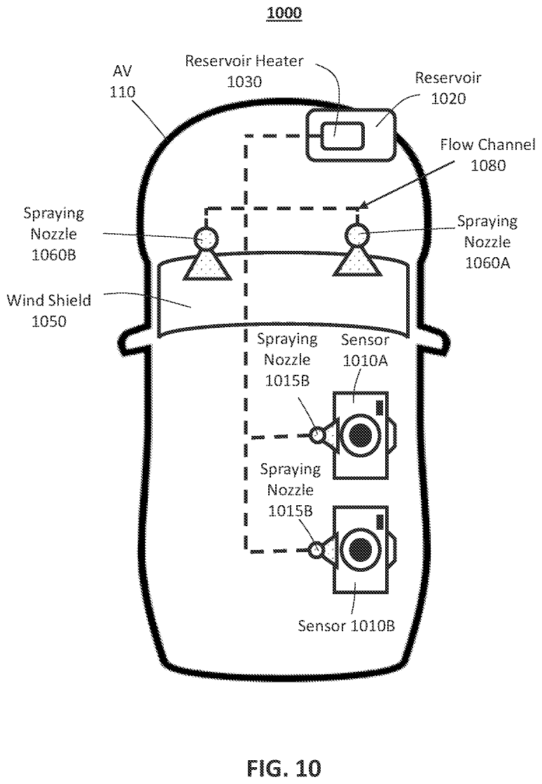

The sensor cleaning module 350 may control one or more heat sources that heat a liquid used to clean sensors. A heat source may be a heat exchanger (e.g., the heat exchanger 440, 540, 545, 645, 945A, or 945B described below in conjunctions with FIGS. 4-6 and 9), a heater (e.g., local heater 730, 745A, 745B, 845A, 845B, 930 described below in conjunctions with FIGS. 7-9 or reservoir heater 1030 930 described below in conjunctions with FIG. 10), or some combination thereof. The sensor cleaning module 350 can control one or more parameters of a heat source. The parameters may include temperature, size, shape, duration of time that the heat source heats a liquid, and so on. In some embodiments, the sensor cleaning module 350 can determine a temperature of a liquid in the heat source, e.g., based on an output of a temperature sensor, e.g., a thermal couple. The sensor cleaning module 350 may determine whether the temperature is at least equal to a threshold temperature. The threshold temperature may be a target temperature of the liquid. In response to determining that the temperature is at least equal to the threshold temperature, the sensor cleaning module 350 may instruct the heat source to let the liquid flow out, e.g., by opening a valve.

The sensor cleaning module 350 may also control a spraying nozzle that sprays a liquid. The onboard computer can control the amount of liquid sprayed by the spraying nozzle, spraying direction, distance from the spraying nozzle to the sensor to be cleaned, flowing speed of the liquid in or at the spraying nozzle, and so on. The onboard computer may also control a flow channel. For instance, the onboard computer can control a flow rate of the liquid flowing in the flow channel, a valve associated with the flow channel, and so on.

The sensor cleaning module 350 may also determine whether a sensor is sufficiently cleaned after a cleaning cycle, e.g., based on sensor data from the sensor itself or the contaminant detector 250. The sensor cleaning module 350 may determine whether the amount of contaminants accumulated on the sensor meets a threshold, or determine whether a performance of the sensor meets a threshold. In response to determining that sensor is sufficiently cleaned, the sensor cleaning module 350 may provide a notification to the sensor interface 320 and the sensor interface 320 can instruct the sensor to capture data to be used by the perception module 330 or control module 340 to control operation of the AV 110. In response to determining that sensor is not sufficiently cleaned, the sensor cleaning module 350 may repeat the cleaning cycle until the sensor is sufficiently cleaned.

In some embodiments, the sensor cleaning module 350 may determine that a sensor is insufficiently cleaned after one or more cleaning cycles. In response to determining that the sensor is insufficiently cleaned, the sensor cleaning module 350 may determine (or instruct the control module 340 to determine) whether the AV 110 can operate with the insufficiently cleaned sensor. For instance, the sensor cleaning module 350 or control module 340 may determine whether the safety and/or passenger comfort meets a threshold safety and/or passenger comfort if the AV 110 operates with the insufficiently cleaned sensor. The sensor cleaning module 350 or control module 340 may consider various factors, such as the type of service being provided or to be provided by the AV 110, the navigation route of the AV 110, the function of the sensor, availability of other sensors, and so on. In embodiments where it is determined that the AV 110 can operate with the insufficiently cleaned sensor, the control module 340 may allow the AV 110 to proceed as normal. The control module 340 may instruct the AV 110 to complete a trip but return for service after the trip is done. In embodiments where it is determined that the AV 110 cannot operate with the insufficiently cleaned sensor, the control module 340 may instruct the AV 110 to navigate to a safe spot (e.g., safely pull over, drive to a nearby parking lot, etc.) or to stop immediately.

### Example Liquid Cleaning Systems

FIG. 4 illustrates an example liquid cleaning system 400 including a heat exchanger 440, according to some embodiments of the present disclosure. The liquid cleaning system 400 is configured to use a liquid to clean sensors 410A and 410B (collectively referred to as “sensors 410” and “sensor 410”) of an AV 110. The sensors 410 may be exterior sensors, e.g., some of the exterior sensors 210 described above in conjunction with FIG. 2. The AV 110 operates, e.g., navigates, based on sensor data captured by the sensors 410. In addition to the heat exchanger 440, the liquid cleaning system 400 also includes spraying nozzles 415A and 415B (collectively referred to as “spraying nozzles 415” and “spraying nozzle 415”), a reservoir 420, spraying nozzles 460A and 460B (collectively referred to as “spraying nozzles 460” and “spraying nozzle 460”), and flow channels 470 and 480. In alternative configurations, fewer, different and/or additional components may be included in the liquid cleaning system 400. Further, functionality attributed to one component of the liquid cleaning system 400 may be accomplished by a different component included in the liquid cleaning system 400 or a different system from those illustrated.

The reservoir 420 stores the liquid to be used to clean the sensors 410 and a wind shield 450 of the vehicle. The liquid includes water. In some embodiments, the liquid may also include methanol, ethanol, ethylene glycol, other chemicals that have cleaning effects, or some combination thereof. The reservoir 420 may include an opening, through which the liquid can flow into the reservoir 420. The liquid can be used to clean the wind shield 450 and/or the sensors 410. In some embodiments, a portion of the liquid is used to clean the wind shield 450, and another portion of the liquid is used to clean the sensors 410. In other embodiments, the liquid can be used to clean other sensors or other parts of the AV 110. The liquid can be warmed up before it is used to clean the wind shield 450 and the sensors 410. With warmer liquid, the cleaning effect can be enhanced.

As shown in FIG. 4, the reservoir 420 is connected to the flow channel 470 that connects the reservoir 420 to the heat exchanger 440. For purpose of simplicity and illustration, the flow channel 470 is shown as a dotted line in FIG. 4. In various embodiments, the flow channel 470 may include one or more tubes (e.g., hose). The flow channel 470 may also include one or more valves that control the flow rate of the liquid. The liquid can flow into the heat exchanger 440 through flow channel 470 from the reservoir 420. The liquid, while in the reservoir 420 and the flow channel 470 may be at a temperature that is lower than the temperature of the heat exchanger 440. For instance, the liquid is at an ambient temperature.

The heat exchanger 440 is associated with a part 430 of the AV 110. The heat exchanger 440 receives the liquid from the reservoir 420 through the flow channel 470. The heat exchanger 440 can transfer heat generated by the part 430 to the liquid. In some embodiments, the heat exchanger 440 includes a container that can store the liquid, e.g., temporarily. The liquid, while being in the container, can receive heat generated by the part 430. The part 430 may be a component or subsystem of the AV 110, such as battery, motor, engine, or other parts of the AV 110 that can generate heat during operations of the AV 110. In some embodiments, the heat is a byproduct of the part 430 during an operation of the part 430. The generation of the heat may not be an intended function of the part 430. Rather, the heat may be an unintended or even undesired result of the operation of the part 430. Too much heat may even impair performance of the part 430 or another part that is adjacent to the part 430 that can receive the heat. By using the heat generated by the part 430 to warm up the liquid can not only enhance the effect of cleaning the sensors 410 with the liquid but also cool down the part 430 to avoid overheating of the part 430 (or overheating of one or more other parts that are adjacent to the part 430). In some embodiments, even when the amount of liquid in the reservoir 420 is too low to spraying liquid onto the sensors 410 or wind shield 450, circulation of the liquid (e.g., flow of the liquid from or back to the reservoir 420) can still be used to cool down the part 430. The heat exchanger 440 is connected to the flow channel 480, through which the liquid, after being heated by the heat exchanger 440, can flow to the spraying nozzles 415 and spraying nozzles 460.

The temperature of the heat exchanger 440 may be the same or similar to the temperature of the part 430. The heat exchanger 440 may be placed at a hot spot in or outside the part 430. The hot spot is a spot that can have a higher temperature than other spots of the part 430 or other parts of the AV 110 (e.g., the reservoir 420) during operations of the AV 110. In some embodiments, the heat exchanger 440 is partially or wholly enclosed by the part 430. Alternatively, the heat exchanger 440 may be outside the part 430. For instance, the heat exchanger 440 can be attached on an exterior surface of the part 430, and the exterior surface of the part 430 can be thermally conductive to transfer heat from the part 430 to the heat exchanger 440.

The flow channel 480 connects the heat exchanger to the spraying nozzles 415 and spraying nozzles 460. For purpose of simplicity and illustration, the flow channel 480 is shown as dashed lines in FIG. 4. In various embodiments, the flow channel 480 may include one or more tubes (e.g., hose). The flow channel 480 may also include one or more valves that control the flow rate of the liquid. When a valve is open, the liquid can flow through it. When the valve is closed, the liquid cannot flow through it. The opening of the valve can be controlled to control the volume or flow rate of the liquid flowing though the valve. In an embodiment, the flow channel may include a valve that controls the flow of the liquid to one or more of the spraying nozzles 415 and 460. For instance, the flow channel includes a first valve that controls the flow of the liquid to the spraying nozzles 460, a second valve that controls the flow of the liquid to the spraying nozzle 415A, and a third valve that controls the flow of the liquid to the spraying nozzle 415B. The flow of the liquid to different ones of the spraying nozzles 415 and 460 can be controlled separately. The valves can be automatic and controlled by the sensor cleaning module 350 of the onboard computer 150, for example.

In some embodiments, the liquid cleaning system 400 includes a single valve that may be upstream from the spraying nozzles 460 and 415 so that the spraying nozzles 460 and 415 may all spray liquid at the same time. In other embodiments, the spraying nozzles 460 and 415 may be controlled by separate valves and can spray liquid at different times, e.g., based on the cleaning need of the sensors 410 and the windshield 450. The two spraying nozzles 415 may be associated with separate valves so that they can spray liquid onto the sensors 410 at different times, which can facilitate the detection of one sensor 410 while the other sensor 410 is being cleaned so that the two sensors 410 are not blinded at the same time. A predetermined pressure may be established by a pump associated with the reservoir 420. There may be a pressure build delay, e.g., a period of time between the activation of the pump and the opening of the valve(s) to allow flow. The liquid cleaning system 400 may also include one or more check valves that allow one-way flow, so that the corresponding flow channel(s) can be “primed” with pressure to minimize the delay to build pressure from pump activation. Additionally or alternatively, the pressure build delay can be minimized by having a pressure monitor within the flow channels and periodically having the reservoir pump rebuild pressure in the flow channels if it bleeds of (although it is protected by check valves, there might be a slow bleed).

Each spraying nozzle 415 is associated with a sensor 410. In other embodiments, a spraying nozzle 415 may be associated with multiple sensors 410. The spraying nozzle 415 can spray liquid from the heat exchanger 440 onto a surface of the sensor 410. The surface may be a surface of an enclosure of the sensor 410, a surface of a window of the sensor 410, an optical surface (e.g., lens, filter, etc.) of the sensor 410, or other types of surfaces. Even though not shown in FIG. 4, a spraying nozzle 415 may be associated with a pump that can pump liquid from the flow channel 480 to the spraying nozzle 415, and the pumping can create a momentum of the liquid to facilitate cleaning of the surface of the sensor 410. The spraying nozzle 415 may also be associated with a wiper that can wipe the surface of the sensor 410 during or after the spraying nozzle 415 sprays the liquid. The spraying nozzles 415 and 460 can be automatic. In some embodiments, a spraying nozzle 415 can receive an instruction from the onboard computer 150 and perform a cleaning cycle in accordance with the instruction.

The spraying nozzles 460 are associated with the wind shield 450. Each spraying nozzle 460 can spray liquid from the heat exchanger 440 onto a portion of the wind shield 450. Even though not shown in FIG. 4, a spraying nozzle 460 may be associated with a pump that can pump liquid from the flow channel 480 to the wind shield 450, and the pumping can create a momentum of the liquid to facilitate cleaning of the surface of the wind shield 450. The spraying nozzle 460 may also be associated with a wiper that can wipe the wind shield 450 during or after the spraying nozzle 460 sprays the liquid. The spraying nozzles 460 and 460 can be automatic. In some embodiments, a spraying nozzle 460 can receive an instruction from the onboard computer 150 and perform a cleaning cycle in accordance with the instruction.

FIG. 5 illustrates another example liquid cleaning system 500 including two heat exchanger 540 and 545, according to some embodiments of the present disclosure. The liquid cleaning system 500 is configured to use a liquid to clean sensors 510A and 510B (collectively referred to as “sensors 510” and “sensor 510”) of an AV 110. The sensors 510 may be exterior sensors, e.g., some of the exterior sensors 210 described above in conjunction with FIG. 2. The AV 110 operates, e.g., navigates, based on sensor data captured by the sensors 510. In addition to the heat exchanger 540, the liquid cleaning system 500 also includes spraying nozzles 515A and 515B (collectively referred to as “spraying nozzles 515” and “spraying nozzle 515”), a reservoir 520, spraying nozzles 560A and 560B (collectively referred to as “spraying nozzles 560” and “spraying nozzle 560”), and flow channels 570, 575, 580, and 585. In alternative configurations, fewer, different and/or additional components may be included in the liquid cleaning system 500. Further, functionality attributed to one component of the liquid cleaning system 500 may be accomplished by a different component included in the liquid cleaning system 500 or a different system from those illustrated.

The reservoir 520 stores the liquid to be used to clean the sensors 510. The liquid includes water. In some embodiments, the liquid may also include methanol, ethanol, ethylene glycol, other chemicals that have cleaning effects, or some combination thereof. The reservoir 520 may include an opening, through which the liquid can flow into the reservoir 520. The liquid can be used to clean the sensors 510 and the wind shield 550. In some embodiments, a portion of the liquid is used to clean the wind shield 550, and another portion of the liquid is used to clean the sensors 510. In other embodiments, the liquid can be used to clean other sensors or other parts of the AV 110. The liquid can be warmed up before it is used to clean the wind shield 550 and the sensors 510. With warmer liquid, the cleaning effect can be enhanced. The reservoir 520 is connected to the flow channel 570. For purpose of simplicity and illustration, the flow channel 570 is shown as a dotted line in FIG. 5. In various embodiments, the flow channel 570 may include one or more tubes (e.g., hose). The flow channel 570 may also include one or more valves that control the flow rate of the liquid. The liquid can flow into the heat exchanger 540 through flow channel 570 from the reservoir 520. The liquid, while in the reservoir 520 and the flow channel 570 may be at a temperature that is lower than the temperature of the heat exchanger 540. For instance, the liquid is at a ambient temperature.

The heat exchanger 540 is associated with a part 530 of the AV 110. The heat exchanger 540 receives the liquid from the reservoir 520 through the flow channel 570. The heat exchanger 540 can transfer heat generated by the part 530 to the liquid. The part 530 may be a battery, motor, engine, or other parts of the AV 110 that can generate heat during operations of the AV 110. In some embodiments, the heat is a byproduct of the part 530 during an operation of the part 530. The generation of the heat may not be an intended function of the part 530. Rather, the heat may be an unintended or even undesired result of the operation of the part 530. Too much heat may even impair performance of the part 530 or another part that is adjacent to the part 530 that can receive the heat. By using the heat generated by the part 530 to warm up the liquid can not only enhance the effect of cleaning the sensors 510 with the liquid but also cool down the part 530 to avoid overheating of the part 530 or one or more other parts that are adjacent to the part 530. The heat exchanger 540 is connected to the flow channel 580, through which the liquid, after being heated by the heat exchanger 540, can flow to the spraying nozzles 515 and spraying nozzles 560.

The temperature of the heat exchanger 540 may be the same or similar to the temperature of the part 530. The heat exchanger 540 may be placed at a hot spot in or outside the part 530. The hot spot is a spot that can have a higher temperature than other spots of the part 530 or other parts of the AV 110 (e.g., the reservoir 520) during operations of the AV 110. In some embodiments, the heat exchanger 540 is partially or wholly enclosed by the part 530. Alternatively, the heat exchanger 540 may be outside the part 530. For instance, the heat exchanger 540 can be attached on an exterior surface of the part 530, and the exterior surface of the part 530 can be thermally conductive to transfer heat from the part 530 to the heat exchanger 540.

The flow channel 580 connects the heat exchanger 540 to the spraying nozzles 560. For purpose of simplicity and illustration, the flow channel 580 is shown as dashed lines in FIG. 5. In various embodiments, the flow channel 580 may include one or more tubes (e.g., hose). The flow channel 580 may also include one or more valves that control the flow rate of the liquid. When a valve is open, the liquid can flow through it. When the valve is closed, the liquid cannot flow through it. The opening of the valve can be controlled to control the volume or flow rate of the liquid flowing though the valve. In an embodiment, the flow channel may include a valve that controls the flow of the liquid to one or both of the spraying nozzles 560. For instance, the flow channel includes a first valve that controls the flow of the liquid to the spraying nozzle 560A and a second valve that controls the flow of the liquid to the spraying nozzle 560B. The flow of the liquid to different ones of the spraying nozzles 515 and 560 can be controlled separately. The valves can be automatic and controlled by the sensor cleaning module 350 of the onboard computer 150, for example.

The spraying nozzles 560 are associated with the wind shield 550. Each spraying nozzle 560 can spray liquid from the heat exchanger 540 onto a portion of the wind shield 550. Even though not shown in FIG. 5, a spraying nozzle 560 may be associated with a pump that can pump liquid from the flow channel 580 to the wind shield 550, and the pumping can create a momentum of the liquid to facilitate cleaning of the surface of the wind shield 550. The spraying nozzle 560 may also be associated with a wiper that can wipe the wind shield 550 during or after the spraying nozzle 560 sprays the liquid. The spraying nozzles 560 and 560 can be automatic. In some embodiments, a spraying nozzle 560 can receive an instruction from the onboard computer 150 and perform a cleaning cycle in accordance with the instruction.

The heat exchanger 545 is associated with the sensors 510. The heat exchanger 545 can receive heat from one or both of the sensors 510 and transfer the heat to liquid inside the heat exchanger 545. In some embodiments, the heat exchanger 545 contacts one or both of the sensors 510. The temperature of the heat exchanger 545 may be the same or similar to the temperature of the sensors 510. The heat exchanger 545 may be placed at or near areas of the sensors 510 where most heat is generated. This can keep the liquid as hot as possible being the liquid is being sprayed to clean the sensors 510. In FIG. 5, the heat exchanger 545 is placed at a side of the sensors 510 that is opposite to the side where the spraying nozzles 515 are located. In other embodiments, the heat exchanger 545 may be arranged at a different area.

The heat exchanger 545 receives the liquid from the reservoir 520 through the flow channel 575. The heat exchanger 545 can transfer heat generated by one or both of the sensors 510 to the liquid. In some embodiments, the heat is a byproduct of the sensors 510 during an operation of the sensors 510. The generation of the heat may not be an intended function of the sensors 510. Rather, the heat may be an unintended or even undesired result of the operation of the sensors 510. Too much heat may even impair performance of the sensors 510 or another part that is adjacent to the sensors 510 that can receive the heat. By using the heat generated by the sensors 510 to warm up the liquid can not only enhance the effect of cleaning the sensors 510 with the liquid but also cool down the sensors 510 to avoid overheating of the sensors 510 or one or more other parts that are adjacent to the sensors 510. The temperature of the liquid is increased in the heat exchanger 545, e.g., to a temperature that is the same or similar as the temperature of a sensor 510. The heat exchanger 545 is connected to the flow channel 585, through which the liquid, after being heated by the heat exchanger 545, can flow to the spraying nozzles 515.

The flow channel 585 connects the heat exchanger 545 to the spraying nozzles 515. For purpose of simplicity and illustration, the flow channel 585 is shown as dashed lines in FIG. 5. In various embodiments, the flow channel 585 may include one or more tubes (e.g., hose). The flow channel 585 may also include one or more valves that control the flow rate of the liquid. When a valve is open, the liquid can flow through it. When the valve is closed, the liquid cannot flow through it. The opening of the valve can be controlled to control the volume or flow rate of the liquid flowing though the valve. In an embodiment, the flow channel may include a valve that controls the flow of the liquid to one or both of the spraying nozzles 515. For instance, the flow channel includes a first valve that controls the flow of the liquid to the spraying nozzle 515A and a second valve that controls the flow of the liquid to the spraying nozzle 515B. The flow of the liquid to different ones of the spraying nozzles 515 and 515 can be controlled separately. The valves can be automatic and controlled by the sensor cleaning module 350 of the onboard computer 150, for example.

Each spraying nozzle 515 is associated with a sensor 510. The spraying nozzle 515 can spray liquid from the heat exchanger 545 onto a surface of the sensor 510. The surface may be a surface of an enclosure of the sensor 510, a surface of a window of the sensor 510, an optical surface (e.g., lens, filter, etc.) of the sensor 510, or other types of surfaces. Even though not shown in FIG. 5, a spraying nozzle 515 may be associated with a pump that can pump liquid from the flow channel 585 to the spraying nozzle 515, and the pumping can create a momentum of the liquid to facilitate cleaning of the surface of the sensor 510. The spraying nozzle 515 may also be associated with a wiper that can wipe the surface of the sensor 510 during or after the spraying nozzle 515 sprays the liquid. The spraying nozzles 515 and 515 can be automatic. In some embodiments, a spraying nozzle 515 can receive an instruction from the onboard computer 150 and perform a cleaning cycle in accordance with the instruction.

The liquid cleaning system 500 have multiple advantages. For example, undesired heat generated from the sensors 510 is used to enhance cleaning efficacy by heating it. This also helps to cool the sensors 510 via this thermal transfer. As another example, the heat exchanger 540 is closer to point of use and therefore, can count for any cooling as the fluid travels through the flow channel 575, even if it was already heated in heat exchanger 540 or even in the reservoir 510.

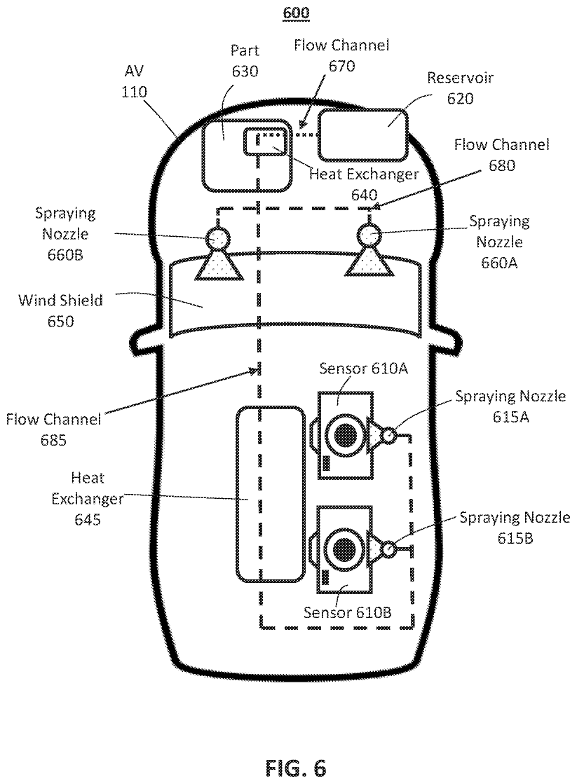

FIG. 6 illustrates an example liquid cleaning system 600 including two heat exchangers 640 and 645, according to some embodiments of the present disclosure. The liquid cleaning system 600 is configured to use a liquid to clean sensors 610A and 610B (collectively referred to as “sensors 610” and “sensor 610”) of an AV 110. The sensors 610 may be exterior sensors, e.g., some of the exterior sensors 210 described above in conjunction with FIG. 2. The AV 110 operates, e.g., navigates, based on sensor data captured by the sensors 610. In addition to the heat exchanger 640, the liquid cleaning system 600 also includes spraying nozzles 615A and 615B (collectively referred to as “spraying nozzles 615” and “spraying nozzle 615”), a reservoir 620, spraying nozzles 660A and 660B (collectively referred to as “spraying nozzles 660” and “spraying nozzle 660”), and flow channels 670, 680, and 685. In alternative configurations, fewer, different and/or additional components may be included in the liquid cleaning system 600. Further, functionality attributed to one component of the liquid cleaning system 600 may be accomplished by a different component included in the liquid cleaning system 600 or a different system from those illustrated.

The reservoir 620 stores the liquid to be used to clean the sensors 610. The liquid includes water. In some embodiments, the liquid may also include methanol, ethanol, ethylene glycol, other chemicals that have cleaning effects, or some combination thereof. The reservoir 620 may be the same or similar as the reservoir 520. The heat exchanger 640 is associated with a part 630 of the AV 110. The heat exchanger 640 receives the liquid from the reservoir 620 through the flow channel 670. The heat exchanger 640 can transfer heat generated by the part 630 to the liquid. The part 630 may be the same or similar as the part 530. The heat exchanger 640 may be the same or similar as the heat exchanger 540. The flow channel 680 connects the heat exchanger 640 to the spraying nozzles 660. The spraying nozzles 660 are associated with the wind shield 650. The spraying nozzles 660 may be the same or similar as the spraying nozzles 560. Also, the flow channels 670 and 680 may be the same or similar as the flow channels 570 and 580, respectively.

The heat exchanger 645 is associated with the sensors 610. The heat exchanger 645 can receive heat from one or both of the sensors 610 and transfer the heat to liquid inside the heat exchanger 645. The heat exchanger 645 may be the same or similar as the heat exchanger 545 in the liquid cleaning system 500. The flow channel 685 connects the heat exchanger 645 to the spraying nozzles 615. Each spraying nozzle 615 can spray liquid from the heat exchanger 645 onto a surface of the corresponding sensor 610. The spraying nozzles 615 may be the same or similar as the spraying nozzles 515 in the liquid cleaning system 500.

Different from the liquid cleaning system 500, in the liquid cleaning system 600, the heat exchanger 645 is connected to the heat exchanger 640 through the flow channel 685. With such as design, the liquid for cleaning the sensors 610 are doubled heated: first in the heat exchanger 640, and then in the heat exchanger 645. By heating the liquid twice, the liquid sprayed by the spraying nozzles 615 in FIG. 6 may have a higher temperature in than liquid sprayed by the spraying nozzles 415 in FIG. 4 or the spraying nozzles 515 in FIG. 5. The double heating of the liquid in the heat exchanger 645 can compensate for heat loss caused by the flow of the liquid in the flow channel 685, e.g., in embodiments where a distance between the reservoir 620 or heat exchanger 640 and the spraying nozzles 615 is relatively long.

FIG. 7 illustrates yet another example liquid cleaning system 700 including local heaters 730, 745A, and 745B, according to some embodiments of the present disclosure. The liquid cleaning system 700 is configured to use a liquid to clean sensors 710A-710D (collectively referred to as “sensors 710” and “sensor 710”) of an AV 110. The sensors 710 may be exterior sensors, e.g., some of the exterior sensors 210 described above in conjunction with FIG. 2. The AV 110 operates, e.g., navigates, based on sensor data captured by the sensors 710. In addition to the heat exchanger 740, the liquid cleaning system 700 also includes spraying nozzles 715A-715D (collectively referred to as “spraying nozzles 715” and “spraying nozzle 715”), a reservoir 720, spraying nozzles 760A and 760B (collectively referred to as “spraying nozzles 760” and “spraying nozzle 760”), and flow channels 770, 775, 780, 785A, and 785B. In alternative configurations, fewer, different and/or additional components may be included in the liquid cleaning system 700. Further, functionality attributed to one component of the liquid cleaning system 700 may be accomplished by a different component included in the liquid cleaning system 700 or a different system from those illustrated.

The reservoir 720 stores the liquid to be used to clean the sensors 710 and a wind shield 750. The liquid includes water. In some embodiments, the liquid may also include methanol, ethanol, ethylene glycol, other chemicals that have cleaning effects, or some combination thereof. A portion of the liquid may be used to clean the sensors 710, and another portion of the liquid may be used to clean the wind shield 750. The reservoir 720 may be the same or similar as the reservoir 420.

The reservoir 720 is connected to the local heater 730 through the flow channel 770. The local heater 730 is local as to the wind shield 750. For instance, the local heater 730 is closer to the wind shield 750 than the sensors 710. The local heater 730 can generate heat, e.g., intended heat, to increase a temperature of liquid when the liquid flows through or stays in the local heater 730. The heated liquid can then flow to the spraying nozzles 760 through the flow channel 780. The spraying nozzles 760 can spray the liquid onto the wind shield 750 to clean the wind shield. The spraying nozzles 760 may be the same or similar as the spraying nozzles 560. The flow channel 780 may be the same or similar as the flow channel 580.

The reservoir 720 is also connected to the local heaters 745A and 745B (collectively referred to as “local heaters 745” and “local heater 745”) through the flow channel 775. The local heaters 745 are local as to the sensors 710. For instance, the local heaters 745 are closer to the sensors 710 than the wind shield 750. In particular, the local heater 745A is associated with the sensors 710A and 710B, the local heater 745B is associated with the sensors 710C and 710D. Each local heater 745 can generate heat, e.g., intended heat, to increase a temperature of liquid when the liquid flows through or stays in the local heater 745. The liquid heated by the local heater 745A flows from the local heater 745A to the spraying nozzles 715A and 715B through the flow channel 785A. The liquid heated by the local heater 745B flows from the local heater 745B to the spraying nozzles 715C and 715D through the flow channel 785B. A local heater 745 may be controlled in a way that the local heater 745 is activated when a liquid flow into the local heater 745 is detected, e.g., by a flow sensor associated with the local heater 745. In other embodiments, a local heater 745 may be activated or deactivated by the sensor cleaning module 350, e.g., to maintain a desired temperature of the liquid flowing through the local heater 745. A local heater 730 or 745 may be integrated with or into a manifold that distributes liquid.

The spraying nozzles 715 can spray the heated liquid onto surfaces of the sensors 710 to clean the sensors. The spraying nozzles 715 may be the same or similar as the spraying nozzles 415. An advantage of using the local heaters 730 and 770 is that the heat loss caused by flow of the liquid along long flow channel lengths can be minimized so that the efficiency of the local heaters 730 and 770 can be maximized.

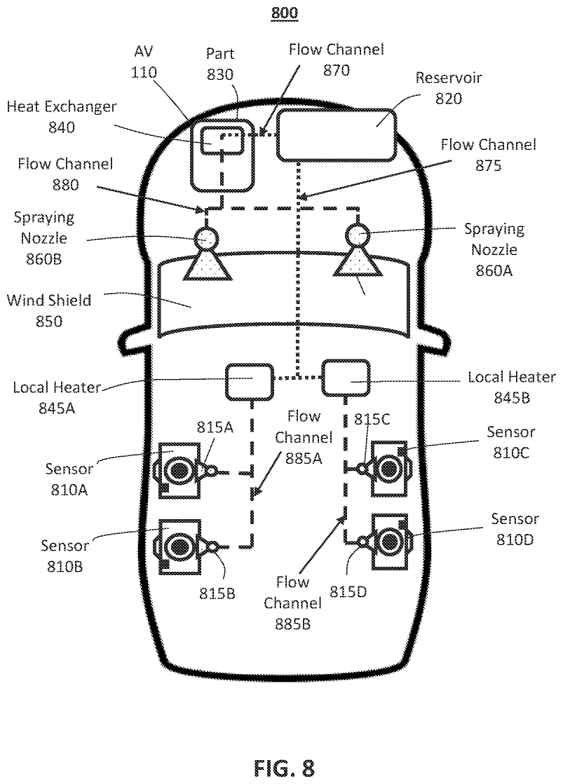

FIG. 8 illustrates an example liquid cleaning system 800 including a heat exchanger 840 and local heaters 880A and 880B (collectively referred to as “local heaters 880” and “local heater 880”), according to some embodiments of the present disclosure. The liquid cleaning system 800 is configured to use a liquid to clean sensors 810A-810D (collectively referred to as “sensors 810” and “sensor 810”) of an AV 110. The sensors 810 may be exterior sensors, e.g., some of the exterior sensors 210 described above in conjunction with FIG. 2. The AV 110 operates, e.g., navigates, based on sensor data captured by the sensors 810. In addition to the heat exchanger 840, the liquid cleaning system 800 also includes spraying nozzles 815A-815D (collectively referred to as “spraying nozzles 815” and “spraying nozzle 815”), a reservoir 820, spraying nozzles 860A and 860B (collectively referred to as “spraying nozzles 860” and “spraying nozzle 860”), and flow channels 870, 875, 880, 885A, and 885B. In alternative configurations, fewer, different and/or additional components may be included in the liquid cleaning system 800. Further, functionality attributed to one component of the liquid cleaning system 800 may be accomplished by a different component included in the liquid cleaning system 800 or a different system from those illustrated.

The reservoir 820 stores the liquid to be used to clean the sensors 810 and a wind shield 850 of the AV 110. The liquid includes water. In some embodiments, the liquid may also include methanol, ethanol, ethylene glycol, other chemicals that have cleaning effects, or some combination thereof. A portion of the liquid may be used to clean the sensors 810, and another portion of the liquid may be used to clean the wind shield 850. The reservoir 820 may be the same or similar as the reservoir 420.

The reservoir 820 is connected to the heat exchanger 840, which is associated with a part 830, through the flow channel 870. The part 830 may be the same or similar as the part 430. The heat exchanger 840 may be the same or similar as the heat exchanger 440. The flow channel 870 may be the same or similar as the flow channel 470. The spraying nozzles 860 receive heated liquid from the heat exchanger 840 through the flow channel 880. The spraying nozzles 860 can spray the heated liquid onto the wind shield 850 to clean the wind shield 850. The spraying nozzles 860 may be the same or similar as the spraying nozzles 560. Thee flow channel 880 may be the same or similar as the flow channel 580.

The reservoir 820 is also connected to the local heaters 845A and 845B (collectively referred to as “local heaters 845” and “local heater 845”) through the flow channel 875. The local heaters 845 are local as to the sensors 810. For instance, the local heaters 845 are closer to the sensors 810 than the wind shield 850. In particular, the local heater 845A is associated with the sensors 810A and 810B, the local heater 845B is associated with the sensors 810C and 810D. Each local heater 845 can generate heat, e.g., intended heat, to increase a temperature of liquid when the liquid flows through or stays in the local heater 845. The liquid heated by the local heater 845A flows from the local heater 845A to the spraying nozzles 815A and 815B through the flow channel 885A. The liquid heated by the local heater 845B flows from the local heater 845B to the spraying nozzles 815C and 815D through the flow channel 885B. The spraying nozzles 815 can spray the heated liquid onto surfaces of the sensors 810 to clean the sensors. The spraying nozzles 815 may be the same or similar as the spraying nozzles 415. An advantage of using the local heaters 845 is that the heat loss caused by flow of the liquid can be minimized so that the efficiency of the local heaters 830 and 870 can be maximized.

FIG. 9 illustrates an example liquid cleaning system 900 including a local heater 930 and heat exchangers 945A and 945B (collectively referred to as “heat exchangers 945” and “heat exchanger 945”), according to some embodiments of the present disclosure. The liquid cleaning system 900 is configured to use a liquid to clean sensors 910A-910D (collectively referred to as “sensors 910” and “sensor 910”) of an AV 110. The sensors 910 may be exterior sensors, e.g., some of the exterior sensors 210 described above in conjunction with FIG. 2. The AV 110 operates, e.g., navigates, based on sensor data captured by the sensors 910. In addition to the heat exchanger 940, the liquid cleaning system 900 also includes spraying nozzles 915A-915D (collectively referred to as “spraying nozzles 915” and “spraying nozzle 915”), a reservoir 920, spraying nozzles 960A and 960B (collectively referred to as “spraying nozzles 960” and “spraying nozzle 960”), and flow channels 970, 975A, 975B, 980, 985A, and 985B. In alternative configurations, fewer, different and/or additional components may be included in the liquid cleaning system 900. Further, functionality attributed to one component of the liquid cleaning system 900 may be accomplished by a different component included in the liquid cleaning system 900 or a different system from those illustrated.

The reservoir 920 stores the liquid to be used to clean the sensors 910 and a wind shield 950. The liquid includes water. In some embodiments, the liquid may also include methanol, ethanol, ethylene glycol, other chemicals that have cleaning effects, or some combination thereof. A portion of the liquid may be used to clean the sensors 910, and another portion of the liquid may be used to clean the wind shield 950. The reservoir 920 may be the same or similar as the reservoir 420.

The reservoir 920 is connected to the local heater 930 through the flow channel 970. The local heater 930 is local as to the wind shield 950. For instance, the local heater 930 is closer to the wind shield 950 than the sensors 910. The local heater 930 can generate heat, e.g., intended heat, to increase a temperature of liquid when the liquid flows through or stays in the local heater 930. The heated liquid can then flow to the spraying nozzles 960 through the flow channel 980. The spraying nozzles 960 can spray the liquid onto the wind shield 950 to clean the wind shield. The spraying nozzles 960 may be the same or similar as the spraying nozzles 560. The flow channel 980 may be the same or similar as the flow channel 580.

The local heater 930 is also connected to the heat exchangers 945A and 945B (collectively referred to as “heat exchangers 945” and “heat exchanger 945”) through the flow channel 975. The heat exchanger 945A is associated with the sensors 910A and 910B. The heat exchanger 945B is associated with the sensors 910C and 910D. Each heat exchanger 945 can receive heat from one or both of the corresponding sensors 910 and transfer the heat to liquid inside the heat exchanger 945. A heat exchanger 945 may be the same or similar as the heat exchanger 545 in the liquid cleaning system 500. The flow channel 985A connects the heat exchanger 945A to the spraying nozzles 915A and 915B. The flow channel 985B connects the heat exchanger 945B to the spraying nozzles 915C and 915D. Each spraying nozzle 915 can spray liquid from the heat exchanger 945 onto a surface of the corresponding sensor 910. The spraying nozzles 915 may be the same or similar as the spraying nozzles 515 in the liquid cleaning system 500.

In the embodiments of FIG. 9, the liquid for cleaning the sensors 910 are doubled heated: first in the local heater 930, then in the heat exchangers 945. By heating the liquid twice, the liquid sprayed by the spraying nozzles 915 in FIG. 9 may have a higher temperature in than liquid sprayed by the spraying nozzles 815 in FIG. 8. The warmer liquid can have better cleaning effects.

FIG. 10 illustrates an example liquid cleaning system 1000 including a reservoir heater 1030, according to some embodiments of the present disclosure. The liquid cleaning system 1000 is configured to use a liquid to clean sensors 1010A and 1010B (collectively referred to as “sensors 1010” and “sensor 1010”) of an AV 110. The sensors 1010 may be exterior sensors, e.g., some of the exterior sensors 210 described above in conjunction with FIG. 2. The AV 110 operates, e.g., navigates, based on sensor data captured by the sensors 1010. In addition to the heat exchanger 1040, the liquid cleaning system 1000 also includes spraying nozzles 1015A and 1015B (collectively referred to as “spraying nozzles 1015” and “spraying nozzle 1015”), a reservoir 1020, spraying nozzles 1060A and 1060B (collectively referred to as “spraying nozzles 1060” and “spraying nozzle 1060”), and flow channels 1080 and 1085. In alternative configurations, fewer, different and/or additional components may be included in the liquid cleaning system 1000. Further, functionality attributed to one component of the liquid cleaning system 1000 may be accomplished by a different component included in the liquid cleaning system 1000 or a different system from those illustrated.

The reservoir 1020 stores the liquid to be used to clean the sensors 1010 and a wind shield 1050 of the vehicle. The liquid includes water. In some embodiments, the liquid may also include methanol, ethanol, ethylene glycol, other chemicals that have cleaning effects, or some combination thereof. The reservoir 1020 may include an opening, through which the liquid can flow into the reservoir 1020. The liquid can be used to clean the wind shield 1050 and the sensors 1010. In some embodiments, a portion of the liquid is used to clean the wind shield 1050, and another portion of the liquid is used to clean the sensors 1010. In other embodiments, the liquid can be used to clean other sensors or other parts of the AV 110. The liquid can be warmed up before it is used to clean the wind shield 1050 and the sensors 1010. With warmer liquid, the cleaning effect can be enhanced.

The reservoir heater 1030 is inside the reservoir 1020. The reservoir heater 1030 can generate heat, e.g., intended heat, to warm up liquid in the reservoir 1020. In some embodiments, the reservoir heater 1030 is partially or wholly immersed in the liquid. The liquid can be in contact with the reservoir heater and be heated by the reservoir heater. In alternative embodiments, the reservoir heater 1030 may be separated from the liquid, e.g., through a wall or a container, which can be thermally conductive and deliver heat from the reservoir heater 1030 to the liquid.

The reservoir is connected to the flow channel 1080 that connects the reservoir 1020 to the spraying nozzles 1015 and spraying nozzles 1060. A portion of the liquid, after heated by the reservoir heater 1030 can flow from the reservoir 1020 to the spraying nozzles 1015 through a part the flow channel 1080. Another portion of the liquid, after heated by the reservoir heater 1030 can flow from the reservoir 1020 to the spraying nozzles 1060 through another part of the flow channel 1080. The spraying nozzles 1015 can spray the liquid onto surfaces of the sensors 1010 and clean the sensors 1010. The spraying nozzles 1060 can spray the liquid onto the wind shield 1050 and clean the wind shield 1050. The flow channel 1080 may be the same or similar as the flow channel 480. The spraying nozzles 1015 may be the same or similar as the spraying nozzles 415. The spraying nozzles 1060 may be the same or similar as the spraying nozzles 460.

### Example Fleet Management System

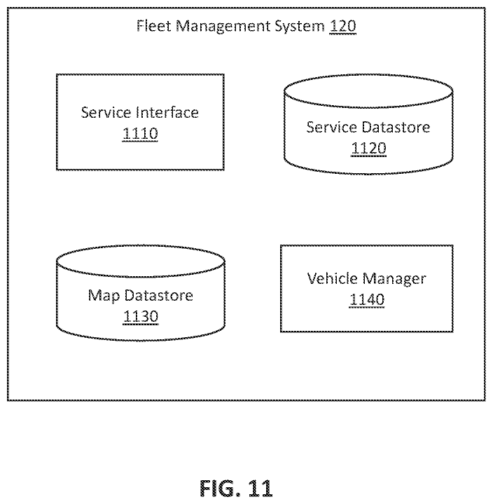

FIG. 11 is a block diagram showing the fleet management system 120, according to some embodiments of the present disclosure. As shown in FIG. 11, the fleet management system 120 includes a service interface 1110, a service datastore 1120, a map datastore 1130, and a vehicle manager 1140. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 150.

The service interface 1110 provides interfaces that allows users (e.g., users 135) to request services that can be provided by AVs associated with the fleet management system 120. In some embodiments, the service interface 1110 provides the interfaces to user devices, such as user devices 130. For example, the service interface 1110 may provide one or more apps or browser-based interfaces that can be accessed by users, such as the users 135, using user devices. The service interface 1110 enables the users to submit service requests provided or enabled by the fleet management system 120 through the interfaces.

The service datastore 1120 stores data associated with services managed by the fleet management system 120. The service datastore 1120 may store information associated with services that the fleet of AVs can provide. The service datastore 1120 may store historical service data. For instance, the service datastore 1120 may also store service requests that have been made by users. The service datastore 1120 may also store information of services that is being performed or has been completed, such as status of service, time when the service was completed, and so on. In some cases, the service datastore 1120 may further include future service data, e.g., a future service that a user has scheduled with the fleet management system 120. In some embodiments, service data stored in the service datastore 1120 may be associated with user accounts maintained by the fleet management system 120. A user may make service requests or access information of historical service requests through the account of the user.

The map datastore 1130 stores a detailed map of environments through which the fleet of AVs may travel. The map datastore 1130 may include some or all data stored in map datastores of the AVs, e.g., the map datastore 310. Some of the map datastore 1130 may be gathered by a fleet of AVs. For example, images obtained by exterior cameras of the AVs may be used to learn information about the AVs' environments. The images may be processed to identify particular features in the environment. Such features may include road conditions, such as road curve, bumps, traffic lights, traffic cones etc. The fleet management system 120 and/or AVs may have one or more image processing modules to identify features in the captured images or other sensor data. This feature data may be stored in the map datastore 1130. In some embodiments, certain feature data (e.g., features that are expected to be temporary) may expire after a certain period of time. In some embodiments, data captured by an AV 110 (e.g., a different AV) may indicate that a previously-observed feature is no longer present (e.g., a traffic cone has been removed) and in response, the fleet management system 120 may remove this feature from the map datastore 1130.

The vehicle manager 1140 manages and communicates with the fleet of AVs 110. The vehicle manager 1140 assigns the AVs 110 to various tasks (e.g., service tasks) and directs the movements of the AVs 110 in the fleet. In some embodiments, the vehicle manager 1140 may direct the movements of the AVs 110 in the fleet based on data in the map datastore 1130. In some embodiments, the vehicle manager 1140 may instruct AVs 110 to drive to other locations while not servicing a user, e.g., to improve geographic distribution of the fleet, to anticipate demand at particular locations, etc. The vehicle manager 1140 may also instruct AVs 110 to return to an AV 110 facility for fueling, inspection, maintenance, or storage. The vehicle manager 1140 may perform some or all of the functions of the onboard computer 150 that are described above in conjunction with FIGS. 1 and 3.

In some embodiments, the vehicle manager 1140 selects AVs from the fleet to perform various tasks and instructs the AVs to perform the tasks. In some embodiments, the vehicle manager 1140 selects an AV 110 based on availability of the AV 110. For example, the vehicle manager 1140 may determine that the AV 110 is available based on a determination that the AV 110 the AV 110 is not performing any task or is going to perform any task that has been assigned to the AV 110. In cases where a service request specifies a time window for the service, the vehicle manager 1140 may determine that the AV 110 is available in the time window. The vehicle manager 1140 may select one of the available AVs based on other factors, such as physical proximity.

The vehicle manager 1140 or another system may maintain or access data describing each of the AVs in the fleet of AVs 110, including current location, service status (e.g., whether the AV 110 is available or performing a service; when the AV 110 is expected to become available; whether the AV 110 is schedule for future service), fuel or battery level, etc. The vehicle manager 1140 may select AVs for service in a manner that optimizes one or more additional factors, including fleet distribution, fleet utilization, and energy consumption. The vehicle manager 1140 may interface with one or more predictive algorithms that project future service requests and/or vehicle use, and select vehicles for services based on the projections.

The vehicle manager 1140 transmits instructions dispatching the selected AVs. In particular, the vehicle manager 1140 instructs a selected AV 110 to drive autonomously to a location. For instance, the vehicle manager 1140 may generates a navigation instruction based on the location and provide the navigation instruction to the selected AV, which will then navigate to the location accordingly. The navigation instruction may include the location itself, a navigation route from another location to the location, road condition information, motion parameters, other types of navigation information, or some combination thereof.

### Select Examples

Example 1 provides a system for cleaning a sensor of a vehicle with a liquid, including: a reservoir to store the liquid; a heat exchanger to: receive the liquid from the reservoir through a first flow channel, and transfer heat from a part of the vehicle to the liquid to heat the liquid, where the heat is a byproduct generated by the part during an operation of the vehicle; and a spraying assembly to: after the liquid is heated, receive the liquid through a second flow channel, and spray the liquid onto a surface of the sensor to clean the sensor with the liquid.

Example 2 provides the system of example 1, where the heat exchanger is affixed to at least a portion of the part.

Example 3 provides the system of example 1, where the part is a battery, motor, or engine of the vehicle.

Example 4 provides the system of example 1, further including: an additional heat exchanger to: receive the liquid from the heat exchanger through a third flow channel, and transfer additional heat from the sensor to the liquid to further heat the liquid, where the additional heat is generated by the sensor during the operation of the vehicle.

Example 5 provides the system of example 4, where the spraying assembly is to receive the liquid from the additional heat exchanger through the second flow channel

Example 6 provides the system of example 1, where the part includes the sensor.

Example 7 provides the system of example 6, where the reservoir is to store an additional liquid, and the system further includes: an additional heat exchanger to: receive the additional liquid from the reservoir through a third flow channel, and transfer additional heat from an additional part of the vehicle to the additional liquid to heat the additional liquid, where the additional heat is a byproduct generated by the additional part during the operation of the vehicle; and an additional spraying assembly to: after the additional liquid is heated, receive the additional liquid through a fourth flow channel, and spray the additional liquid onto a wind shield of the vehicle to clean the wind shield.

Example 8 provides the system of example 1, where the reservoir is to store additional liquid, the heat exchanger is to transfer additional heat from the part of the vehicle to the additional liquid to heat the additional liquid, and the system further includes: an additional spraying assembly to: after the additional liquid is heated, receive the additional liquid through a third flow channel, and spray the additional liquid onto a wind shield of the vehicle to clean the wind shield.

Example 9 provides the system of example 8, where the liquid is a first portion of a cleaning liquid in the reservoir, and the additional liquid is a second portion of the cleaning liquid.

Example 10 provides the system of example 1, where the sensor is affixed to an exterior surface of the vehicle.

Example 11 provides a system for cleaning a sensor of a vehicle with a liquid, including: a reservoir to store the liquid; a heater to: receive the liquid from the reservoir through a first flow channel, and heat the liquid, where the heater is closer to the sensor than the reservoir; and a spraying assembly to: after the liquid is heated, receive the liquid through a second flow channel, and spray the liquid onto a surface of the sensor to clean the sensor with the liquid.

Example 12 provides the system of example 11, further including: an additional heater to: receive an additional liquid from the reservoir through a third flow channel, and heat the additional liquid, where the additional heater is closer to an additional sensor than the reservoir; and an additional spraying assembly to: after the additional liquid is heated, receive the additional liquid through a fourth flow channel, and spray the additional liquid onto a surface of the additional sensor to clean the additional sensor with the additional liquid.

Example 13 provides the system of example 11, further including: a heat exchanger that is located on the first flow channel and is between the reservoir and the heater, the heater to: receive the liquid from the reservoir through a portion of the first flow channel, and transfer heat from a part of the vehicle to the liquid to heat the liquid, where the heat is a byproduct generated by the part during an operation of the vehicle, and the heater is to receive the liquid from the heat exchanger through another portion of the first flow channel.

Example 14 provides the system of example 11, where the sensor is affixed to an exterior surface of the vehicle.

Example 15 provides the system of example 11, further including: an additional heater to: receive an additional liquid from the reservoir through a third flow channel, and heat the additional liquid, where the additional heater is closer to the reservoir than the sensor; and an additional spraying assembly to: after the additional liquid is heated, receive the additional liquid through a fourth flow channel, and spray the additional liquid onto a wind shield of the vehicle to clean the wind shield with the additional liquid.

Example 17 provides the system of example 11, where the reservoir is to store an additional liquid, the heater is to receive the additional liquid from the reservoir through the first flow channel and heat the additional liquid, and the system further includes: an additional spraying assembly to: after the additional liquid is heated, receive the additional liquid through a third flow channel, and spray the additional liquid onto a wind shield of the vehicle to clean the wind shield with the additional liquid.

Example 18 provides the system of example 17, where the liquid is a first portion of a cleaning liquid in the reservoir, and the additional liquid is a second portion of the cleaning liquid.

Example 19 provides a system for cleaning a sensor of a vehicle with a liquid, including: a reservoir to store the liquid; a heater to: receive the liquid from the reservoir through a first flow channel, and heat the liquid, where the heater is inside the reservoir; and a spraying assembly to: after the liquid is heated, receive the liquid through a second flow channel, and spray the liquid onto a surface of the sensor to clean the sensor with the liquid.

Example 20 provides the system of example 19, where the reservoir is to store an additional liquid, the heater is to receive the additional liquid from the reservoir through the first flow channel and heat the additional liquid, and the system further includes: an additional spraying assembly to: after the additional liquid is heated, receive the additional liquid through a third flow channel, and spray the additional liquid onto a wind shield of the vehicle to clean the wind shield with the additional liquid.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A system for cleaning a sensor of a vehicle with a liquid, comprising:
a reservoir to store the liquid;
a heat exchanger to:
receive the liquid from the reservoir through a first flow channel, and
transfer heat from a part of the vehicle to the liquid to heat the liquid,
wherein the heat is a byproduct generated by the part during an operation of the vehicle; and
a spraying assembly to:
after the liquid is heated, receive the liquid through a second flow channel, and
spray the liquid onto a surface of the sensor to clean the sensor with the liquid.

2. The system of claim 1, wherein the heat exchanger is affixed to at least a portion of the part.

3. The system of claim 1, wherein the part is a battery, motor, or engine of the vehicle.

4. The system of claim 1, further comprising:
an additional heat exchanger to:
receive the liquid from the heat exchanger through a third flow channel, and
transfer additional heat from the sensor to the liquid to further heat the liquid,
wherein the additional heat is generated by the sensor during the operation of the vehicle.

5. The system of claim 4, wherein the spraying assembly is to receive the liquid from the additional heat exchanger through the second flow channel

6. The system of claim 1, wherein the part includes the sensor.

7. The system of claim 6, wherein the reservoir is to store an additional liquid, and the system further comprises:
an additional heat exchanger to:
receive the additional liquid from the reservoir through a third flow channel, and
transfer additional heat from an additional part of the vehicle to the additional liquid to heat the additional liquid,
wherein the additional heat is a byproduct generated by the additional part during the operation of the vehicle; and
an additional spraying assembly to:
after the additional liquid is heated, receive the additional liquid through a fourth flow channel, and
spray the additional liquid onto a wind shield of the vehicle to clean the wind shield.

8. The system of claim 1, wherein the reservoir is to store an additional liquid, the heat exchanger is to transfer additional heat from the part of the vehicle to the additional liquid to heat the additional liquid, and the system further comprises:
an additional spraying assembly to:
after the additional liquid is heated, receive the additional liquid through a third flow channel, and
spray the additional liquid onto a wind shield of the vehicle to clean the wind shield.

9. The system of claim 8, wherein the liquid is a first portion of a cleaning liquid in the reservoir, and the additional liquid is a second portion of the cleaning liquid.

10. The system of claim 1, wherein the sensor is affixed to an exterior surface of the vehicle.

11. A system for cleaning a sensor of a vehicle with a liquid, comprising:
a reservoir to store the liquid;
a heater to:
receive the liquid from the reservoir through a first flow channel, and
heat the liquid,
wherein the heater is closer to the sensor than the reservoir; and
a spraying assembly to:
after the liquid is heated, receive the liquid through a second flow channel, and
spray the liquid onto a surface of the sensor to clean the sensor with the liquid.

12. The system of claim 11, further comprising:
an additional heater to:
receive an additional liquid from the reservoir through a third flow channel, and
heat the additional liquid,
wherein the additional heater is closer to an additional sensor than the reservoir; and
an additional spraying assembly to:
after the additional liquid is heated, receive the additional liquid through a fourth flow channel, and
spray the additional liquid onto a surface of the additional sensor to clean the additional sensor with the additional liquid.

13. The system of claim 11, further comprising:
a heat exchanger that is located on the first flow channel and is between the reservoir and the heater, the heater to:
receive the liquid from the reservoir through a portion of the first flow channel, and
transfer heat from a part of the vehicle to the liquid to heat the liquid,
wherein the heat is a byproduct generated by the part during an operation of the vehicle, and the heater is to receive the liquid from the heat exchanger through another portion of the first flow channel.

14. The system of claim 11, wherein the sensor is affixed to an exterior surface of the vehicle.

15. The system of claim 11, further comprising:
an additional heater to:
receive an additional liquid from the reservoir through a third flow channel, and
heat the additional liquid,
wherein the additional heater is closer to the reservoir than the sensor; and
an additional spraying assembly to:
after the additional liquid is heated, receive the additional liquid through a fourth flow channel, and
spray the additional liquid onto a wind shield of the vehicle to clean the wind shield with the additional liquid.

17. The system of claim 11, wherein the reservoir is to store an additional liquid, the heater is to receive the additional liquid from the reservoir through the first flow channel and heat the additional liquid, and the system further comprises:
an additional spraying assembly to:
after the additional liquid is heated, receive the additional liquid through a third flow channel, and
spray the additional liquid onto a wind shield of the vehicle to clean the wind shield with the additional liquid.

18. The system of claim 17, wherein the liquid is a first portion of a cleaning liquid in the reservoir, and the additional liquid is a second portion of the cleaning liquid.

19. A system for cleaning a sensor of a vehicle with a liquid, comprising:
a reservoir to store the liquid;
a heater to:
receive the liquid from the reservoir through a first flow channel, and
heat the liquid,
wherein the heater is inside the reservoir; and
a spraying assembly to:
after the liquid is heated, receive the liquid through a second flow channel, and
spray the liquid onto a surface of the sensor to clean the sensor with the liquid.

20. The system of claim 19, wherein the reservoir is to store an additional liquid, the heater is to receive the additional liquid from the reservoir through the first flow channel and heat the additional liquid, and the system further comprises:
an additional spraying assembly to:
after the additional liquid is heated, receive the additional liquid through a third flow channel, and
spray the additional liquid onto a wind shield of the vehicle to clean the wind shield with the additional liquid.
